(19) United States
(12) Patent Application Publication
(10) Pub. No.: US 2013/0070910 A1
(43) Pub. Date: Mar. 21, 2013

(54) Advanced Adaptive Communications System (ACS)

(71) Applicant: Daniel O'Sullivan, Southold, NY (US)

(72) Inventor: Daniel O'Sullivan, Southold, NY (US)

(21) Appl. No.: 12/171,196

(22) Filed: Jul. 10, 2008

(51) Int. Cl. H04M 1/64

(52) U.S. Cl. 379/88.01

(57) ABSTRACT

This invention allows a system to monitor how quickly and accurately the user is responding via the input device. The input device can be a mouse, a keyboard, their voice, a touch-screen, a tablet PC writing instrument, a light pen or any other commercially available device used to input information from the user to the PBCD. Information is displayed on the PBCD screen based on how quickly and accurately the user is navigating with the input device.

### CROSS REFERENCE TO RELATED APPLICATIONS

This application for letters patent is a continuation of provisional patents for VoiceXL for VXML and VoiceXL for Processors applications filed on Aug. 25, 2004, Multimodal VoiceXL filed on Aug. 4, 2003, VoiceXL Provisional Patent Application filed on May 20, 2003, Easytalk Provisional Patent Application filed on May 9, 2001 and U.S. Pat. No. 5,493,608.

### STATEMENT REGARDING FEDERALLY SPONSORED RESEARCH OR DEVELOPMENT

Not Applicable.

### BACKGROUND OF THE INVENTION

This invention is a modification to my U.S. Pat. No. 5,493,608 for a caller adaptive voice response system (CAVRS).

### BRIEF SUMMARY OF THE INVENTION

This invention allows a system to monitor and adjust to how the user is responding via the input device.

### DETAILED DESCRIPTION OF THE INVENTION

What follows is a description of certain improvements over previous patents filings and prototypes.

### Adaptive Audio DLL Version 5.0

### Enhanced Features Description

### Jul. 10, 2008

1. Input Modality Switching

Adaptive Audio Version 5.0 supports Input Modality Switching (IMS) based on individual caller navigation skills and navigation success rates and skill levels at each node in the call script. The IMS feature determines which mode of input (Speech or DTMF) would have the greatest chance of success and fastest execution time for the current Call Script Node (CSN).

The IMS feature is implemented via a call to the Adaptive Audio API function:
adaptiveAudioAsk(PORT_NUMBER, CSN_NUMBER) which is called at the start of each CSN in the voice application.

The adaptiveAudioAsk( ) function returns a value indicating whether it will be best to use Speech, DTMF or either mode as input to the current CSN.

Feature Benefits: Increased call automation rates, reduced error rates, increased customer satisfaction and reduced automated call times.

2. Adaptive Timeout Control

The Adaptive Timeout Control (ATC) feature allows the voice application to dynamically extend timeout values for individual callers having difficulty navigating particular areas of the application script. Since Adaptive Audio is constantly aware of when a particular caller is experiencing difficulty navigating any or all of the call script, it can signal the voice application to allow an appropriate amount of extra time for this caller to respond.

The ATC feature is implemented via a call to the Adaptive Audio API function:
adaptiveAudioAsk(PORT_NUMBER, CSN_NUMBER)

The adaptiveAudioAsk( ) function returns a value indicating how many additional seconds should be allowed for the caller to respond to the current CSN. This is a delta value that is added to the existing timeout value for the CSN.

Feature Benefits: Increased call automation rates, reduced error rates, increased customer satisfaction and reduced CSR transfers and abandoned calls.

3. Preemptive Abandonment Alerts

The Preemptive Abandonment Alerts (PAA) feature keeps a cumulative index of how well each individual caller is navigating the call script. This is represented internally in the Adaptive Audio API software module by a Caller Frustration Index value. When the CFI value approaches a certain threshold (programmable in the Adaptive Audio configuration file) it signals the voice application that a preemptive transfer to a CSR may be advisable, thus avoiding an abandoned call.

The PAA feature is implemented via a call to the Adaptive Audio API function:
adaptiveAudioAsk(PORT_NUMBER, CSN_NUMBER)

The adaptiveAudioAsk( ) function returns a value indicating whether a CSR intervention is advisable based on the callers experience with the automated system and likelihood that they will hang up and abandon the call. The feature also eliminates wasted time and reduces caller frustration by transferring calls that will ultimately end up as callbacks or CSR transfers anyway.

Feature Benefits: Reduction in abandoned calls and callbacks, increased customer satisfaction and reduced overall call times.

4. Node Adaptive WPM Control

The Node Adaptive WPM Control feature automatically adjusts the WPM speaking rate up or down based on the level of difficulty of each CSN as represented by the historical behavioral data collected at each CSN by Adaptive Audio. This feature is fully automatic once optioned in the Adaptive Audio configuration file and no further action is required by the developer in order for the process to take place.

Feature Benefits: Increased call automation rates, reduced error rates, increased customer satisfaction and reduced CSR transfers and abandoned calls.

5. Adaptive Phrase Insertion

The Adaptive Phrase Insertion (API) informs the application developer when it would be advisable to insert one or more of a set of pre-recorded supportive voice prompts into the audio output stream. The supportive voice prompts would be inserted in context and actual content would be relevant based on the caller's progress up to a particular point in the automated call.

The API feature is implemented via a call to the Adaptive Audio API function:
adaptiveAudioAsk(PORT_NUMBER, CSN_NUMBER)

The adaptiveAudioAsk( ) function returns a value indicating which (if any) additional supportive phrase should be inserted.

Feature Benefits: Increased call automation rates, increased customer satisfaction and reduced CSR transfers and abandoned calls.

6. Auto-Recalibration Feature

Adaptive Audio version 5.0 will support automatic recalibration over time as designated by parameters specified in the AA configuration file. Recalibration can be set to occur after a specified volume of call have been taken, CSN's have been traversed, by hour of day, day of week, month or year, by calendar date or for holidays and seasonal anomalies.

7. Adaptive Pause Insertion

Adaptive Audio version 5.0 will support automatic insertion of appropriate silence or pauses when needed in the call script and based on an individual's performance at navigation the call script. This feature is programmable via the AA configuration file parameters.

8. Adaptive Application Reconfiguration

This is a feature that allows AA to use the data collected via the Behavior Analytics Reporting described below to dynamically and automatically adjust the content, dialogue flow, timing, tempo, nuance, inflection, WPM rates, modality and conversational turn-taking for optimal IVR operation. This will be done automatically by the software, without the need for human intervention and will effectively allow AA to automatically optimize and voice application over time.

9. Conversational Turn-Taking

This feature will use historical behavioral data collected at individual CSN's, the caller frustration index, instantaneous and average skill levels and other situation dependent data to determine when to pause and when to interrupt the caller during conversational or DTMF dialogue.

Behavior Analytics Reporting

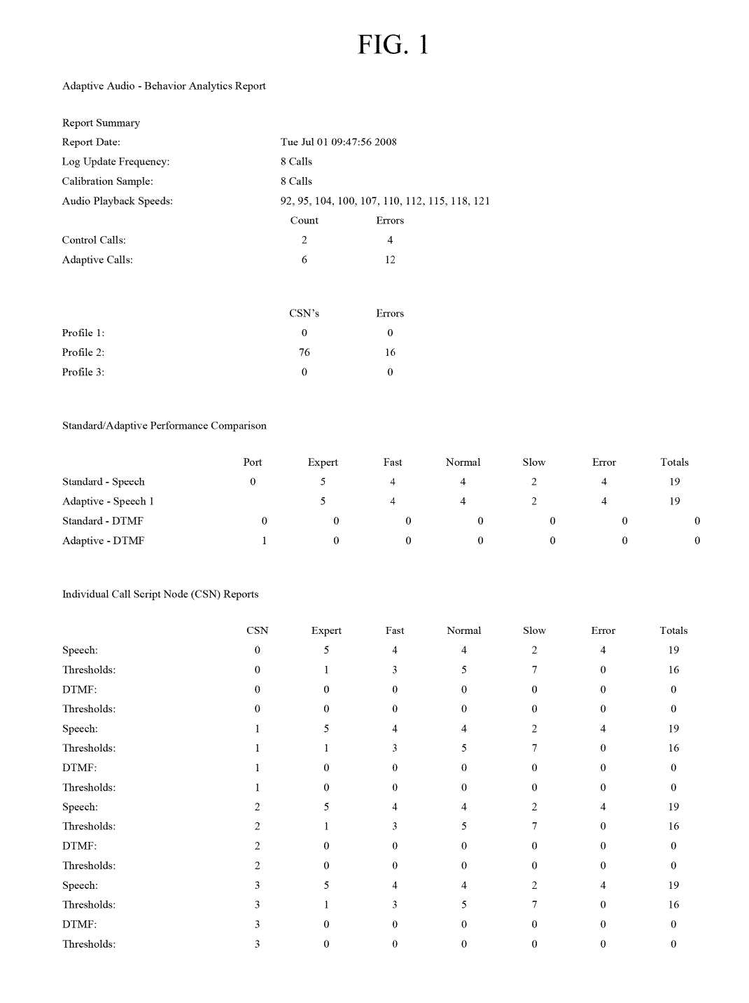

Adaptive Audio Version 5.0 provides Behavior Analytics Reporting as shown in FIG. 1 and will also include:

1. Reports showing the navigation patterns of callers throughout the application script. Popular and erroneous patterns will be reported to illustrate how callers use the system and to gain insight into how to improve the voice application. This information will also be used by Adaptive Audio to improve and tweak performance and characteristics of the application.

2. A listing of the highest Error CSN's will be provided showing the most erroneous CSN's in order. Also included will be difficulty ratings for each CSN.

3. An overall IVR usability index will be provided. This will be a number between for example 1 and 100 that reflects the overall performance of the IVR in terms of reduced error rates, increased call automation, reduced call durations, reduced abandonment rates and the like.

FIG. 1 shows enhanced call reporting for adaptive audio.

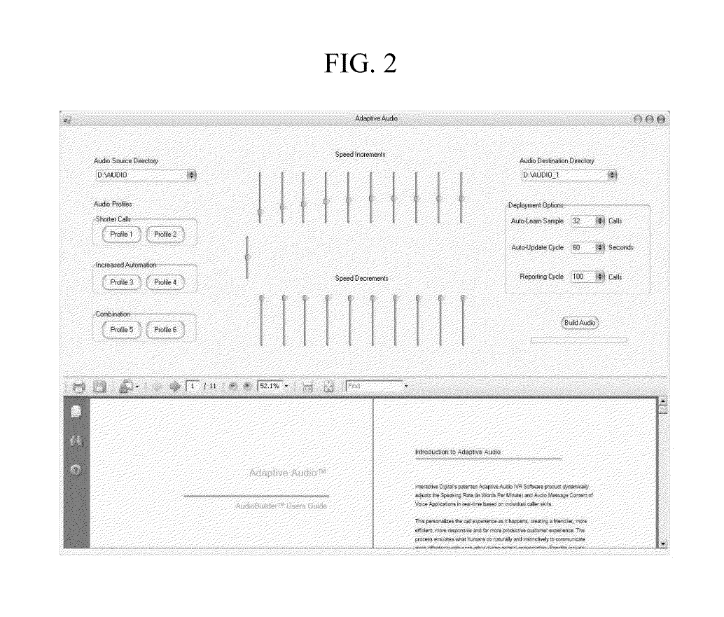

FIG. 2 is an AudioBuilder User Interface Screen Shot.

### Adaptive Audio DLL Version 4.0

### Proposed Design Modifications for Additional Best Practice Techniques

Aug. 29, 2007

The following table can be used to drive a state machine within the DLL to accomplish modality switching, message content selection, audio playback speed control and other actions. We need to define the Threshold—Action parameters for each set of call metrics.

| | | Thresh- | Thresh- |
|---|---|---|---|
| | Threshold - | old 2 - | old 3 - |
| Call Metric | Action 1 | Action | Action |
| User_Is_Engaged | | | |
| Background_Noise | | | |
| User_Closer_To_Goal | | | |
| User_Wants_Operator | | | |
| User_Is_MonkeyButt | | | |
| Last_Interaction_Modality | | | |
| Most_Recent _Garbage_In_A_Row | | | |
| User_Knows_Yes_And_No | | | |

Adaptive Audio API Modifications

Modifications required to the DLL API are marked in blue below.
API Function 1: adaptiveAudioStart(PORT_NUMBER)
   Input Parameters: 1—Port Number as a unique integer value (0-1023)

### Return Values: 0=PASS

−1=FAIL—String containing reason for failure also returned
   Description: Adaptive Audio™ needs to know when a call is originated to allow for call session parameter initialization. This function must be called at the start of each incoming phone call to accomplish this task. FIGS. 3 and 4 below indicate the setup required for this step.
API Function 2: adaptiveAudioAsk(PORT_NUMBER, CSN_NUMBER)
   Input Parameters: 1—Port Number as a unique integer value (0-1023)
   2—CSN as a unique integer value (0-1023)

### Return Values: 0=PASS

−1=FAIL—String containing reason for failure also returned
   Description: The adaptiveAudioAsk( ) function is called at the beginning of each CSN at which you want to incorporate Adaptive Audio's adaptive functionality. This signals the beginning of voice play for a particular CSN in the application script. FIG. 5 below indicates the setup required for this step.
API Function 3: adaptiveAudioAnswer(PORT_NUMBER, CSN_NUMBER, RESPONSE_STATUS, RESPONSE_TYPE)
   Input Parameters: 1—Port Number as a unique integer value (0-1023)
   2—CSN as a unique integer value (0-1023)
   3—0 if Valid Response, 1 if Invalid Response
   4—0 if Touch-Tone Response, 1 if Speech Response
      Return Value: 00—09=PASS. Value is next RPS for Normal Touch-Tone prompts
   10—19=PASS. Value is next RPS for Terse Touch-Tone prompts
   20—29=PASS. Value is next RPS for Elaborate Touch-Tone prompts
   30—39=PASS. Value is next RPS for Normal Speech prompts
   40—49=PASS. Value is next RPS for Terse Speech prompts
   50—59=PASS. Value is next RPS for Elaborate Speech prompts
   60—69=PASS. Value is next RPS for Normal Combination prompts
   70—79=PASS. Value is next RPS for Terse Combination prompts
   80—89=PASS. Value is next RPS for Elaborate Combination prompts
   −1=FAIL—String containing reason for failure also returned [PD1]
      Description: The adaptiveAudioAnswer( ) function is called at the end of each CSN at which you want to incorporate Adaptive Audio's adaptive functionality. The end of a CSN is defined as the point at which a response (whether valid or invalid) is received from the caller. Data collected in the auto-learn phase of the application session is used by the adaptiveAudioAnswer( ) function to determine if this caller response warrants a change in the RPS level. FIGS. 6-8 below indicate the setup required for this step.
      RPS2—Relative Playback Speed. This is a single digit integer between 0 and 9 that designates a particular APS3. There are 10 RPS values allowed with Adaptive Audio™. These are:
      RPS=0-2 represent APS values below normal
      RPS=3 represents Normal Playback
      RPS=4-9 represent APS values above normal
      APS3—Absolute Playback Speed. This is defined as a flat percentage of the originally recorded voice files playback speed. The APS of the voice applications existing prompts is defined as 100 percent. The values required for an Adaptive Audio™ implementation always have an APS of between 85-125 percent. Typical values are 110, 114, 117 and 119.
API Function 4: adaptiveAudioSuspend(PORT_NUMBER)
   Input Parameters: 1—Port Number as a unique integer value (0-1023)

### Return Values: 0=PASS

−1=FAIL—String containing reason for failure also returned
   Description: The adaptiveAudioSuspend( ) API function suspends operation of the Adaptive Audio™ process until a subsequent adaptiveAudioResume( ) function call is made. Voice playback continues throughout the application at the RPS level achieved just prior to the adaptiveAudioSuspend( ) call.
API Function 5: adaptiveAudioPreset(PORT_NUMBER, RPS_PRESET)
   Input Parameters: 1—Port Number as a unique integer value (0-1023)
   2—Desired RPS preset value (0-9)

Return Values: 0=PASS
−1=FAIL—String containing reason for failure also returned

Description: The adaptiveAudioPreset( ) API function call forces voice playback to the RPS value passed in to the function via the RPS parameter. The Adaptive Audio™ process continues from this RPS level forward in the application unless an adaptiveAudioSuspend( ) call is active.

API Function 6: adaptiveAudioResume(PORT_NUMBER)

Input Parameters: 1—Port Number as a unique integer value (0-1023)

Return Values: 0=PASS
−1=FAIL—String containing reason for failure also returned

Description: The adaptiveAudioResume( ) API function call resumes operation of the Adaptive Audio™ process at the last RPS value attained by the caller.

1.-2. (canceled)

3. A method, comprising:
receiving a call at an interactive voice response system, the voice response system being programmed with a call flow including a plurality of call script nodes;
measuring performance of a caller associated with the call at at least one of the plurality of call script nodes; and
modifying the call flow based on the measuring the performance.

4. The method of claim 3, wherein the modifying includes one of maintaining or changing an input modality.

5. The method of claim 4, wherein the input modality is one of speech or DTMF input.

6. The method of claim 3, further comprising measuring the performance at multiple of the plurality of call script nodes.

7. The method of claim 3, wherein the measuring the performance includes measuring at least one of a caller navigation skill level or a caller navigation success rate.

8. The method of claim 3, wherein the modifying the call flow includes dynamically extending a timeout value for the caller based on a determination that the caller is having difficulty navigating a call script node.

9. The method of claim 8, wherein the dynamically extending includes extending the timeout value for a prescribed time period.

10. The method of claim 3, wherein the modifying includes transferring a caller to a customer service representative when a caller frustration index value approaches a predetermined threshold.

11. The method of claim 10, wherein the caller frustration index is based on a determination that the caller is having difficulty navigating the call flow based on the measuring the performance at the call script nodes.

12. The method of claim 3, wherein the modifying includes modifying the spoken words per minute of at least a portion of the call flow based on a determination that at least a portion of the callers are having difficulty with the portion of the call flow.

13. The method of claim 12, wherein the at least a portion of the callers includes a majority of callers to the call flow.

14. The method of claim 3, wherein the modifying includes inserting an additional pre-recorded phrase into the call flow based on a determination that a caller is having difficulty with a call script node.

15. The method of claim 14, wherein the additional pre-recorded phrase is inserted is a supportive phrase.

16. The method of claim 3, further comprising:
generating a report based on data associated with caller navigation patterns of the call flow.

17. The method of claim 16, wherein the report includes data associated with an error rate for at least one of the plurality of call script nodes.

18. A non-transitory processor-readable medium storing code representing instructions to be executed by a processor, the code comprising code to cause the processor to:
receive a call at an interactive voice response system, the voice response system being programmed with a call flow including a plurality of call script nodes;
measure performance of a caller associated with the call at at least one of the plurality of call script nodes; and
modify the call flow based on measuring the performance.

19. The non-transitory processor-readable medium of claim 18, wherein the code to modify the call flow includes code to maintaining or changing an input modality.

20. The non-transitory processor-readable medium of claim 18, wherein the code to modify the call flow includes code to dynamically extend a timeout value for the caller based on a determination that the caller is having difficulty navigating a call script node.

21. The non-transitory processor-readable medium of claim 18, wherein the code to modify the call flow includes code to transfer a caller to a customer service representative when a caller frustration index value approaches a predetermined threshold.

22. The non-transitory processor-readable medium of claim 18, wherein the code to modify the call flow includes code to modify the spoken words per minute of at least a portion of the call flow based on a determination that at least a portion of the callers are having difficulty with the portion of the call flow.

23. The non-transitory processor-readable medium of claim 18, wherein the code to modify the call flow includes code to insert an additional pre-recorded phrase into the call flow based on a determination that a caller is having difficulty with a call script node.

24. The non-transitory processor-readable medium of claim 18, the code further comprising code to cause the processor to generate a report based on data associated with caller navigation patterns of the call flow.
